(19) United States
(12) Patent Application Publication
(10) Pub. No.: US 2025/0207857 A1
(43) Pub. Date: Jun. 26, 2025

(54) CONVERSION KIT FOR A TREATMENT SYSTEM AND METHOD FOR CONVERTING A TREATMENT SYSTEM

(71) Applicant: Dürr Systems AG, Stuttgart (DE)

(72) Inventors: Oliver IGLAUER-ANGRIK, Stuttgart (DE); Kevin WOLL, Heilbronn (DE); Heiko DIETER, Besigheim (DE); Jochen JETTER, Bietigheim-Bissingen (DE); Izzet BEKDEMIR, Bönnigheim (DE); Damir WAGNER, Asperg (DE)

(21) Appl. No.: 18/850,986

(22) PCT Filed: May 23, 2023
(86) PCT No.: PCT/DE2023/100380

§ 371 Date: Sep. 25, 2024

(30) Foreign Application Priority Data
May 24, 2022 (DE) 10 2022 113 079.7

(51) Int. Cl. F26B 23/00; F23G 7/06; F26B 3/04; F26B 15/00

(52) U.S. Cl. CPC F26B 23/002; F23G 7/063; F26B 3/04; F23G 2206/10; F26B 15/00; F26B 2210/12

(57) ABSTRACT

A conversion kit (202), which is suitable for the conversion of a treatment plant, in particular an existing treatment plant, for treating workpieces, in particular drying vehicle bodies, wherein the conversion kit (202) comprises the following:
one or more auxiliary heating apparatuses (206, 208, 210), which are suitable for heating a clean gas guided in a clean gas guide system (126) and/or fresh air guided in a fresh air guide system (122); and
a) a regenerative thermal oxidation apparatus (204) as replacement for an in particular fossil fuel-heated, thermal post-combustion apparatus (142); or
b) a regenerative thermal oxidation apparatus (204) as replacement for a fresh air heat exchanger (144) and a converted, in particular fossil fuel-heated, thermal post-combustion apparatus (142) for use as fresh air heat exchanger (150); or
c) a regenerative thermal oxidation apparatus (204) as replacement for an in particular fossil fuel-heated, thermal post-combustion apparatus (142) and electrically heated recirculated air modules (214) as replacement for recirculated air modules (110) having heat exchangers or converted recirculated air modules (214) having electrical heating registers instead of heat exchangers.

### RELATED APPLICATION

This application is a national phase of international application No. PCT/DE2023/100380 filed on May 23, 2023, and claims the benefit of German application No. 10 2022 113 079.7 filed on May 24, 2022, which are incorporated herein by reference in their entirety and for all purposes.

### FIELD OF DISCLOSURE

The present disclosure relates to a conversion kit for the conversion of a treatment plant, in particular an existing treatment plant, for treating workpieces, in particular drying vehicle bodies, and to a method for the conversion of a treatment plant.

As part of efforts to combat global warming, more and more automobile manufacturers are considering changing existing treatment plants or drying plants in the bodywork sector from fossil fuel firing (gas, oil, etc.) to heating by means of electrical energy from renewable energy sources.

### BACKGROUND

The prior art for the heating of such drying plants, or dryers for short, is the combination of exhaust air purification and heat supply. Here, the remaining residual heat in the cleaned dryer exhaust air, which is also referred to as clean gas, is utilized in downstream heat recovery systems for heating the recirculated air in the recirculated air units or modules of the individual dryer zones or portions and for heating the fresh air in the fresh air units or fresh air heat exchangers, before the exhaust air is subsequently discharged into the atmosphere (via the roof).

For the technical ventilation of drying plants in the bodywork sector, a continual exchange of dryer atmosphere containing solvents (exhaust air) for a solvent-free fresh air flow is provided. To this end, with the aid of an exhaust air fan, an exhaust air volume flow is taken off at one or more locations of the treatment space or of the drying tunnel and supplied to an apparatus for exhaust air purification, usually a recuperative thermal post-combustion system (TAR).

When a TAR is used, the cleaned exhaust air volume flow, that is to say the clean gas, is available at a temperature of about 450° C. for the dryer heating.

Recirculated air modules having a dedicated heat exchanger are used to heat the individual dryer portions, while the clean gas flow is cooled along the clean gas guide system connecting the recirculated air modules.

Lastly, the clean gas flow flows through a fresh air heat exchanger and leaves the drying plant at a temperature of for example 130° C. via the roof.

Alternatively or additionally conceivable are recirculated air modules which each comprise a separate burning apparatus or are coupled to such a burning apparatus, as a result of which the recirculated air modules are configured in such a way that they can heat the respectively local recirculated air flow which is guided in a local recirculated air guide system through the respectively assigned treatment space portion.

The minimum exhaust air volume flow is determined by the standard on the basis of the lower explosion limit, but is in practice correspondingly higher, such that the dryer energy demand can be covered by the clean gas enthalpy flow.

When changing the drying plants from fossil fuel-based heating to electrical heating, it is obvious to use the possibilities of an electrical direct heating system.

A direct heating system transforms electrical energy into heat energy. For this, the current flows in a heating coil or a heating wire. A resistance is generated there, which in turn produces heat. By way of heat conductors such as heating ribs, the heat is passed directly to the air flow to be temperature-controlled (e.g. recirculated air or fresh air).

Fossil fuel-based heating is accompanied by an exhaust gas flow containing harmful substances such as nitrogen oxides which must not pass into the dryer atmosphere because these have a negative effect on the paint quality.

For this reason, fossil fuel-heated drying plants are equipped with an indirect heating system, in which in particular series-connected heat exchangers which are preferably integrated into the recirculated air modules are used to transfer the heat energy of the flue gas, i.e. of the gaseous combustion product in the technical combustion of fuels, or of the clean gas in the central exhaust air purification or processing apparatus to the dryer atmosphere, which comprises both recirculated air and fresh air, without any physical mixing of both media, i.e. no mixing of flue gas or clean gas with recirculated air and fresh air.

If such systems of fossil fuel-based heating are to be changed to electrical heating, then it is known from the prior art and also from new plants to dismantle the existing plant parts for indirect heat transfer and to exchange them for electrical heating registers.

These electrical heating registers are then incorporated for example as decentralized heat sources in the recirculated air units and/or fresh air units.

The purification of the dryer exhaust air is then effected separately from the heating of the dryer. Thermal methods for purifying the solvent-containing and malodorous exhaust air are generally also used here.

These processes can be brought to operating temperature using fossil fuels or alternatively using electrical energy. As soon as the system reaches operating temperature, it is often the case—depending on the solvent load—that only the heat energy released by the oxidation of solvents is required to achieve self-sufficient, autothermic operation.

However, when changing from fossil fuel-based heating to electrical heating of drying plants, it is known from practice to draw on concepts used when setting up new plants.

These concepts entail the following disadvantages and problems in the case of existing plants.

The installation of a decentralized electrical heating system, in which the individual recirculated air and fresh air units are equipped with a dedicated electrical heating register, requires a high degree of mechanical conversion work at the individual units, since inter alia the clean gas heat exchanger must be replaced with an electrical heating register. In addition, a high degree of electrical installation work at the individual recirculated air units is required, which includes the positioning of the switchgear cabinet with connection to the heating register and the positioning, including the connection, of the unit substation with a low-voltage installation.

Furthermore, the placement or positioning of one or more unit substations for supplying power to the individual heating registers in the context of a decentralized electrical heating system largely determines the cable lengths to the individual heating registers and the associated costs.

Added to this is the fact that free installation areas are rare especially in an existing plant.

Furthermore, the conversion also means dismantling the existing heating concept, i.e. dismantling the clean gas line along the entire dryer length, dismantling the clean gas ducts and flaps in the region of the recirculated air/fresh air units and potentially dismantling the exhaust air duct to the TAR. The latter is dependent on where the new exhaust air purification system is intended to or can be located.

A further factor which should be considered is the high expenditure in terms of time and money entailed by a conversion, because such a conversion or such a modification can hardly be realized in a shutdown phase and also requires sufficiently available manpower.

### SUMMARY

The present disclosure is based on the object of providing a conversion kit which enables an efficient conversion of treatment plants to electrical heating.

This object is achieved according to examples disclosed herein by means of a conversion kit having the features as claimed in claim 1.

The conversion kit according to examples disclosed herein serves or is suitable for the conversion of a treatment plant, in particular an existing treatment plant, for treating workpieces, in particular drying vehicle bodies.

The conversion kit according to examples disclosed herein comprises the following:
one or more auxiliary heating apparatuses, which are suitable for heating a clean gas guided in a clean gas guide system and/or fresh air guided in a fresh air guide system; and
a) a regenerative thermal oxidation apparatus as replacement for an in particular fossil fuel-heated, thermal post-combustion apparatus (hereinafter also referred to as case a)); or
b) a regenerative thermal oxidation apparatus as replacement for a fresh air heat exchanger and a converted, in particular fossil fuel-heated, thermal post-combustion apparatus for use as fresh air heat exchanger (hereinafter also referred to as case b)); or
c) a regenerative thermal oxidation apparatus as replacement for an in particular fossil fuel-heated, thermal post-combustion apparatus and electrically heated recirculated air modules as replacement for recirculated air modules having heat exchangers or converted recirculated air modules having electrical heating registers instead of heat exchangers (hereinafter also referred to as case c)).

The treatment plant to be converted, which preferably is or includes an existing treatment plant with a convertible basic structure, has a conveying direction and comprises the following:
a treatment space which comprises a plurality of treatment space portions which are each assigned to a separate recirculated air module, each of which comprises a heat exchanger;
an exhaust air guide system which discharges exhaust air from the treatment space;
the in particular fossil fuel-heated, thermal post-combustion apparatus for processing, in particular for cleaning, the exhaust air, which is intended to be converted or exchanged;
a clean gas guide system which guides cleaned exhaust air, in particular clean gas, wherein the clean gas guide system preferably runs at least approximately parallel to the conveying direction; and
a fresh air supply which supplies fresh air to the treatment space.

Furthermore, the treatment space preferably comprises a pretreatment space, which is arranged upstream of the treatment space in relation to the conveying direction, and/or an aftertreatment space, which is arranged downstream of the treatment space in relation to the conveying direction.

Examples disclosed herein are based on the fundamental idea that the work for the conversion of a treatment plant should be kept as low as possible and the amount of components of the existing plant that continue to be used or are reused is as high as possible. Accordingly, the conversion to electrical heating is not directed at a direct heating system, but rather is aimed at making the existing indirect heating system compatible for electrical heating.

Consequently, the TAR which has hitherto been fired with fossil fuels is substituted by an electrical and thus flameless regenerative thermal oxidation apparatus (F-RTO), which preferably comprises a single-bed exhaust air purification system, and the dryer exhaust air is used as heat transfer medium for the electrical heating.

The clean gas infrastructure can therefore also continue to be used, in particular for the central and indirect electrical heating of the dryer.

Different positions within the treatment plant are suitable for the F-RTO. On the one hand, the F-RTO can be positioned at the start of the heat train, i.e. directly downstream of the point where the exhaust air is conducted out of the dryer, use being made of the temperature swing of the exhaust air purification for the heating of the exhaust air by about 20 K. On the other hand, the F-RTO could be positioned at the end of the heat transfer train, i.e. downstream of the fresh air unit or fresh air heat exchanger, the use of the temperature swing then being effected with the aid of other heat recovery measures.

It is particularly advantageous if the F-RTO includes a single horizontal, electrically heated bed and the throughflow direction can be cyclically switched by way of disk valves. When the bed is flowed through, preheating to the core is effected, which results in a chemical conversion without supply of a combustion gas. The gas subsequently cools on the other half of the bed.

It may be favorable if the F-RTO is operated autothermically as soon as the solvent concentration has exceeded a certain limit value. In the case of an autothermic reaction, it is for example possible to gain about 20 K in temperature at a solvent concentration of 1 g/m³, the temperature gain increasing with increasing solvent concentration. The F-RTO can preferably have a catalytic effect.

Preferably, all the electrically operated heating components (such as inter alia the electrically operated auxiliary heating apparatuses) of the converted treatment plant can be supplied with a mean voltage of for example at least approximately 3 kV and/or at most approximately 8 kV, in particular 4160 V to 6600 V, instead of the customary 400 V. This may indeed require special heating elements with corresponding additional costs, but preferably offers large saving potential in the periphery, i.e. with respect to the connections, cables, etc. Furthermore, a substantially lower factor of the voltage transformation from the supply network is required, this inter alia reducing the size of the transformer station to the benefit of lower capital costs and saving space. The connection to an electrically operated heating component with such a mean voltage also entails considerably lower cable diameters.

In one embodiment of examples disclosed herein, provision may be made for the treatment plant to be converted to further comprise a fresh air heat exchanger which is designed to transfer heat energy contained in the clean gas to fresh air supplied to the treatment plant.

In a further embodiment of examples disclosed herein, provision may be made for the one or more auxiliary heating apparatuses to be purely electrically operated, hydrogen-operated or thermal oil-operated auxiliary heating apparatuses.

However, in the case of thermal oil-operated auxiliary heating apparatuses, the corresponding upper temperature limit should be borne in mind.

In a further embodiment of examples disclosed herein, provision may be made for the regenerative thermal oxidation apparatus to be a purely electrically operated, flameless, regenerative thermal oxidation apparatus.

In a further embodiment of examples disclosed herein, provision may be made for the one or more purely electrically operated auxiliary heating apparatuses and/or the purely electrically operated, flameless, regenerative thermal oxidation apparatus to be able to be connected to a central electrical connection point, in particular to a unit substation.

A central electrical connection point can not only save on installation space but also reduce the costs.

In a further embodiment of examples disclosed herein, provision may be made for the regenerative thermal oxidation apparatus to comprise a fan for conveying an air flow.

In a further embodiment of examples disclosed herein, provision may be made, in the case b) of exchanging the fresh air heat exchanger for a regenerative thermal oxidation apparatus, for the in particular fossil fuel-heated, thermal post-combustion apparatus of the treatment plant to be able to be used, in particular after the conversion, as fresh air heat exchanger.

The old TAR serves as new fresh air heat exchanger at its previous installation location. After conversion, the TAR of the treatment plant has become obsolete as processing apparatus and the effective internal heat exchanger thereof is used at the end of the exhaust air train for the heating of the fresh air.

In a further embodiment of examples disclosed herein, provision may be made, in the case c), for the clean gas to be able to be guided exclusively to the fresh air heat exchanger by means of the clean gas guide system, i.e. in particular for the clean gas to not be guided through the recirculated air modules.

In a further embodiment of examples disclosed herein, provision may be made, in the case of a) and c), for the clean gas guide system to be able to be flowed through in the conveying direction.

Existing treatment plants in which the position of the TAR is in the region of the outlet of the treatment space and conversely the fresh air heat exchanger is arranged in the region of the inlet are also known. In the case of such an arrangement, a conversion of the plant according to cases a) and c) would nevertheless result in the clean gas guide system continuing to be flowed through counter to the conveying direction.

Whereas, in a further embodiment of examples disclosed herein, provision may be made, in the case of b), for the clean gas guide system to be able to be flowed through counter to the conveying direction.

In a further embodiment of examples disclosed herein, provision may be made for the regenerative thermal oxidation apparatus to be arranged at an end of the clean gas guide system in relation to the conveying direction.

In a further embodiment of examples disclosed herein, provision may be made for the fresh air heat exchanger to be in the form of a thermal oil circuit or in the form of a run-around coil system.

Such an embodiment of the fresh air heat exchanger is particularly advantageous if the oxidation apparatus is arranged too far away, such as outside the building, from the treatment space, because sensible and latent heat energy can be efficiently transferred from the locally more remote exhaust air flow to the fresh air required for the treatment space by means of a thermal oil circuit or a run-around coil system.

Provision may alternatively or additionally be made for one or more high-temperature auxiliary heating apparatuses or high-temperature auxiliary heating registers to be arranged downstream of the oxidation apparatus.

A high-temperature auxiliary heating apparatus comprises or is designed as an electrical heating element preferably in the form of a tubular or round-tubular heating body, the heat being generated in a current-carrying heating conductor. This heating conductor is preferably embedded centrally in a highly compacted magnesium oxide layer, resulting in high electrical insulation with good heat conduction.

By means of one or more high-temperature auxiliary heating apparatuses, the cleaned exhaust air or the clean gas can be heated to a temperature of 450° C. to 480° C., that is to say it is possible to provide a clean gas temperature for heating the dryer that is comparable to the temperatures which were available with the previous use of TAR in treatment plants.

Such a high-temperature auxiliary heating apparatus is preferably arranged suspended in the treatment plant, as a result of which friction due to acting normal forces, as is the case with a conventional horizontal and abutting arrangement of tubes, is avoided.

A plurality of high-temperature auxiliary heating apparatuses are preferably arranged one after the other in a row, wherein, when using more than one high-temperature auxiliary heating apparatus, these are preferably of identical design, i.e. in particular with the same surface load of for example 1 W/cm² to 2 W/cm². The use of identical high-temperature auxiliary heating apparatuses minimizes the number of pieces to be kept available for a possible exchange.

Examples disclosed herein are also based on the object of providing a method which makes it possible to convert a treatment plant, in particular an existing treatment plant, to an exhaust air-reduced, electrically heated treatment plant.

This object is achieved according to examples disclosed herein by means of a method as claimed in the independent method claim.

Preferably, the conversion method is based on the treatment plant to be converted being a treatment plant for treating workpieces, in particular drying vehicle bodies, which has a conveying direction and comprises the following:
a treatment space which comprises a plurality of treatment space portions which are each assigned to a separate recirculated air module, each of which comprises a heat exchanger;
an exhaust air guide system which discharges exhaust air from the treatment space;
an in particular fossil fuel-heated, thermal post-combustion apparatus for processing, in particular for cleaning, the exhaust air, which is intended to be converted or exchanged;
a clean gas guide system which guides cleaned exhaust air, in particular clean gas;
a fresh air heat exchanger which transfers heat energy contained in the clean gas to fresh air supplied to the treatment plant; and
a fresh air supply which supplies fresh air via the fresh air heat exchanger to the treatment space.

The method comprises the following steps:
installing one or more auxiliary heating apparatuses in the clean gas guide system and/or the fresh air supply; and
a) replacing the thermal processing apparatus with a regenerative thermal oxidation apparatus; or
b) replacing the fresh air heat exchanger with a regenerative thermal oxidation apparatus and converting the in particular fossil fuel-heated, thermal post-combustion apparatus for use as fresh air heat exchanger; or
c) replacing the thermal processing apparatus with a regenerative thermal oxidation apparatus and replacing the recirculated air modules having heat exchangers with electrically heated recirculated air modules or replacing the heat exchangers of the recirculated air modules with electrical heating registers.

The method preferably has one or more of the features and/or advantages described in connection with the conversion kit.

The conversion kit preferably also has one or more of the features and/or advantages described in connection with the method.

In the second alternative of case c), the previous recirculated air modules are retained, i.e. preferably left in their position, and the respective heat exchangers are preferably replaced with electrical heating registers.

In one embodiment of examples disclosed herein, provision may be made for the one or more purely electrically operated, hydrogen-operated or thermal oil-operated auxiliary heating apparatuses and/or the purely electrically operated, preferably flameless, regenerative thermal oxidation apparatus to be connected to a central electrical connection point, in particular to a unit substation.

In a further embodiment of examples disclosed herein, provision may be made, in the case of b), for the in particular fossil fuel-heated, thermal post-combustion apparatus of the treatment plant to be converted to continue to be used as fresh air heat exchanger.

In a further embodiment of examples disclosed herein, provision may be made, in the case of a) and c), for the clean gas guide system to be flowed through by the clean gas in the conveying direction.

In one embodiment of examples disclosed herein, provision may be made, in the case of b), for the clean gas guide system to be flowed through by the clean gas counter to the conveying direction.

In one embodiment of examples disclosed herein, provision may be made for the exhaust air to be guided at least partially or at least approximately completely through the purely electrically operated, preferably flameless, regenerative thermal oxidation apparatus and in so doing to be at least temporarily heated to a temperature which brings about a chemical transformation of substances, in particular solvents, contained in the air flow, and for at least part of the heat temporarily contained in the exhaust air to be recovered, with the result that the clean gas leaves the purely electrically operated, preferably flameless, regenerative thermal oxidation apparatus at a temperature which lies between an input temperature and a temporary maximum temperature.

Further preferred features and/or advantages of examples disclosed herein are the subject of the description below and of the diagrammatic illustration of exemplary embodiments.

### BRIEF DESCRIPTION OF THE DRAWINGS

FIG. 1 shows a schematic illustration of a basic structure of a treatment plant;

FIG. 2 shows a schematic illustration of a first embodiment of a converted treatment plant;

FIG. 3 shows a schematic illustration of a second embodiment of a converted treatment plant;

FIG. 4 shows a schematic illustration of a third embodiment of a converted treatment plant;

FIG. 5 shows a schematic illustration of a fourth embodiment of a converted treatment plant;

FIG. 6 shows a schematic illustration of a fifth embodiment of a converted treatment plant; and

FIG. 7 shows a schematic illustration of the air connection of an oxidation apparatus.

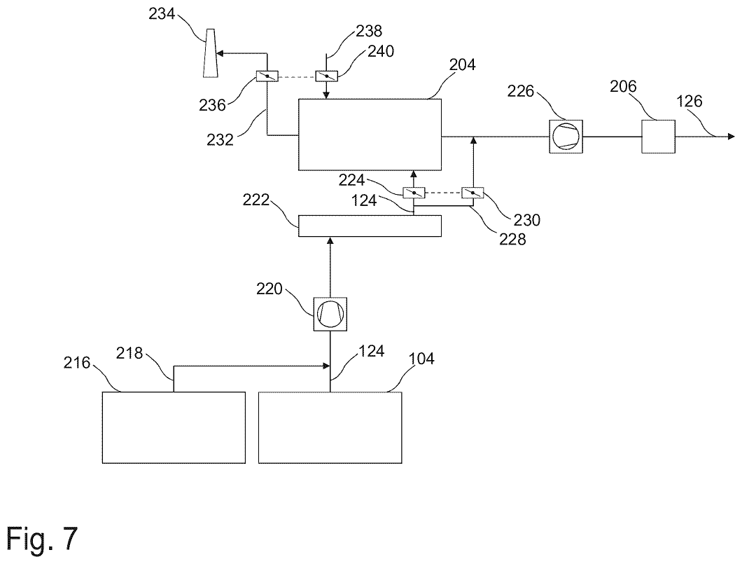

Identical or functionally equivalent elements are provided with the same reference signs in all of the figures.

### DETAILED DESCRIPTION OF THE DRAWINGS

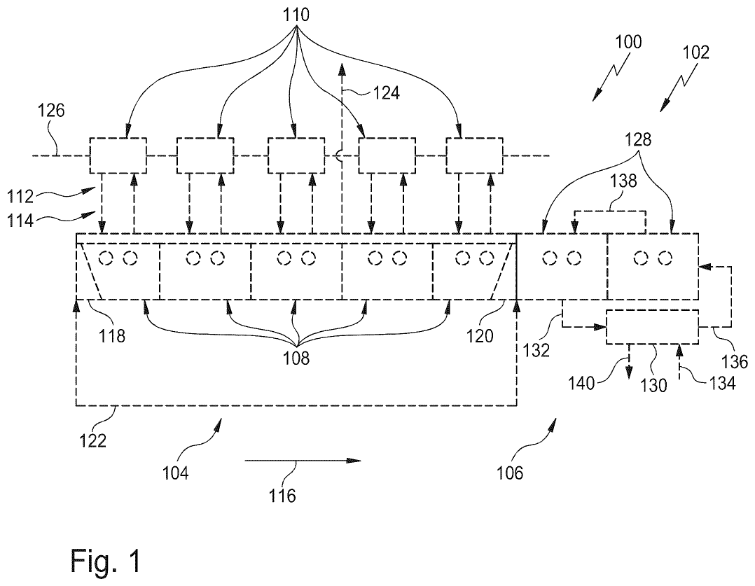

A basic structure, illustrated in FIG. 1 and denoted as a whole by 100, of a treatment plant, in particular of an existing treatment plant, serves for the treatment of workpieces (not illustrated), in particular for the drying of vehicle bodies.

The treatment plant basic structure 100 is in particular a basic structure of a dryer 102 for drying precoated vehicle bodies.

The treatment plant basic structure 100 should be understood to be the foundation of a treatment plant forming the basis for a conversion, or the components thereof continue to be used and/or are functionally and/or structurally incorporated in the converted plant. All the components of the treatment plant basic structure 100 should therefore also be understood to be present in a treatment plant, in particular an existing treatment plant.

The treatment plant basic structure 100 comprises a treatment space 104 and an aftertreatment space 106.

The treatment space 104 comprises a plurality of treatment space portions 108.

The treatment space portions 108 are assigned to a plurality of separate recirculated air modules 110 of the treatment plant 100.

The recirculated air modules 110 each circulate a local recirculated air flow 112 in a local recirculated air guide system 114 through the respectively assigned treatment space portion 108.

The recirculated air modules 110 preferably each comprise a fan and a heat exchanger.

The workpieces to be treated, in particular vehicle bodies, are conveyed through the treatment space 104 and the aftertreatment space 106 in a conveying direction 116.

The treatment space 104 further comprises an admission lock 118 and/or a discharge lock 120, which are supplied via a fresh air guide system 122 with preferably preheated fresh air for the formation of an air silhouette.

It is also conceivable for the fresh air guide system 122 to additionally or alternatively be connected to at least one of the recirculated air modules 110 or to supply at least one recirculated air module 110 with fresh air.

Exhaust air is discharged, preferably centrally, from the treatment space 104 via an exhaust air guide system 124.

Processed exhaust air or clean gas is guided through a clean gas guide system 126.

The clean gas guide system 126 is thermally coupled to the recirculated air modules 110, with the result that the heat energy contained in the clean gas can be transferred to the local recirculated air flows 112.

The aftertreatment space 106 follows the treatment space 104 in the conveying direction 116.

However, it is also conceivable for a cooling zone (not illustrated), in which the treated workpieces are actively and/or passively cooled, to be arranged between the aftertreatment space 106 and the treatment space 104.

The aftertreatment space 106 comprises a plurality of aftertreatment space portions 128.

The aftertreatment space 106 is assigned a fresh air heat exchanger 130 which transfers the heat energy contained in an exhaust air flow 132 to a supplied fresh air flow 134. It is, however, more common to add a partial flow from the exhaust air flow 132 to the fresh air flow 134.

A preheated fresh air flow 136 is supplied to one of the aftertreatment space portions 128 by the fresh air heat exchanger 130.

A recirculated air flow 138 is formed between the aftertreatment space portions 128.

After at least part of the heat energy has been transferred, the exhaust air flow 132 is discharged downstream of the fresh air heat exchanger 130 as a cooled exhaust air flow 140. In the case of exhaust air being added to the fresh air flow, the proportion of exhaust air that is not reused leaves the treatment plant 100 via the roof.

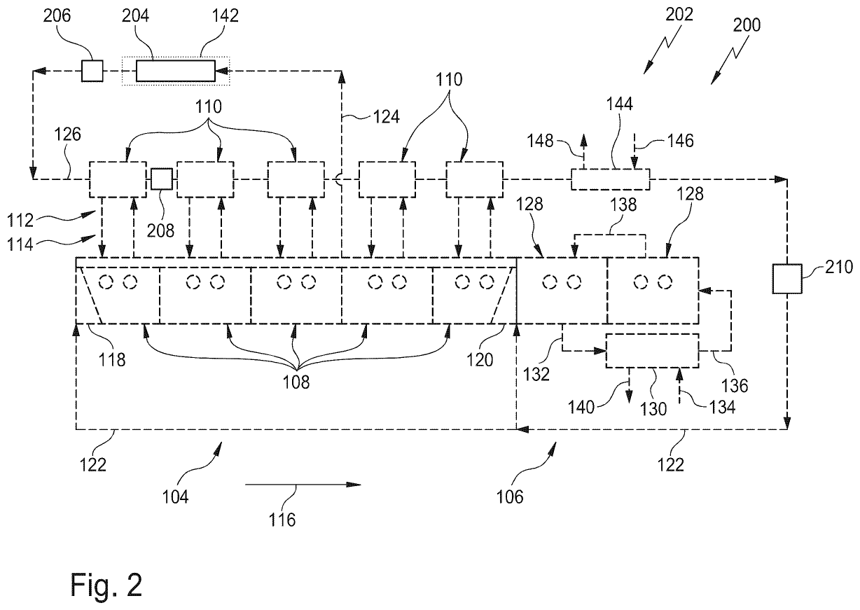

The basic structure, illustrated in FIG. 1, of a treatment plant 100 forms the basis in FIGS. 2 to 6 for the description of the conversion components and conversion method steps.

The basic structure 100 or the plant infrastructure of the existing treatment plant and the corresponding components which continue to be used after the conversion are illustrated as dashed symbols or with dashed lines in FIGS. 1 to 6. The schematic position of the components which are replaced or exchanged as part of the conversion are illustrated as dotted symbols or with dotted lines in the figures. In addition, the components of the treatment plant basic structure 100 are labeled with reference signs in the range from 100 to 199, whilst conversion or new components are labeled with reference signs in the range from greater than or equal to 200.

FIG. 2 illustrates a first embodiment of a converted treatment plant 200 converted using a conversion kit 202.

In the embodiment of the converted treatment plant 200 illustrated in FIG. 2, exhaust air is discharged from the treatment space 104 via the discharge air guide system 124 and supplied to a purely electrically operated, preferably flameless, regenerative thermal oxidation apparatus 204.

The oxidation apparatus 204 replaces, at the corresponding position, a previously used, in particular fossil fuel-heated, thermal post-combustion apparatus 142.

Consequently, the in particular fossil fuel-heated or fossil fuel-fired post-combustion apparatus 142 is substituted by the electrically heated oxidation apparatus 204 and the temperature swing due to the purification or processing of the exhaust air in the oxidation apparatus 204 is used for the heating of the treatment space portions 108.

The processed exhaust air or the clean gas is additionally heated by an electrically operated auxiliary heating apparatus 206 downstream of the oxidation apparatus 204 so that the heat input into the local recirculated air flows 112 is sufficient for the treatment of the workpieces, i.e. in particular the drying of the vehicle bodies.

Where required, it is possible for further electrically operated auxiliary heating apparatuses 208 to be arranged between the recirculated air modules 110 in order to be able to provide the local recirculated air flows 112 with enough heat energy over the entire length of the treatment space 104.

The arrangement of further electrically operated auxiliary heating apparatuses 208 between the recirculated air modules 110 also avoids an excessive heat output and excessive inevitable surface temperatures at the electrically operated auxiliary heating apparatus 206.

The clean gas flows through the clean gas guide system 126 in the conveying direction 116 and, in a fresh air heat exchanger 144 which may in particular be part of the treatment plant basic structure 100, transfers its heat energy to supplied fresh air 146, in order to then be discharged as cooled clean gas flow 148 via the roof.

Regulating flaps (not illustrated) also continue to be used in the region of the fresh air heat exchanger 144 and the recirculated air modules 110.

Preferably, a further electrically operated auxiliary heating apparatus 210 is arranged in the fresh air guide system 122 in order to be able to discharge the cleaned exhaust air or the clean gas downstream of the fresh air heat exchanger as cooled clean gas flow 148 at low temperature into the atmosphere or via the roof.

For this, the enthalpy flow via the roof should be kept as low as possible, which is why it is appropriate to merely preheat the fresh air with the aid of the fresh air heat exchanger 144. The further electrically operated auxiliary heating apparatus 210 is then used to effect the remaining, required temperature swing by means of direct heating of the fresh air flow in the fresh air guide system 122.

The electrically operated auxiliary heating apparatus 210 in the fresh air guide system 122 additionally performs a further function, specifically the compensation of temperature fluctuations in the fresh air which occur during the required, cyclic switching of the throughflow direction in the single bed of the oxidation apparatus 204.

The accurately temperature-controlled fresh air is lastly preferably supplied via the fresh air supply 122 to the admission lock 118 and/or to the discharge lock 120 and from there recirculated in the local recirculated air flows 112 of the treatment space portions 110.

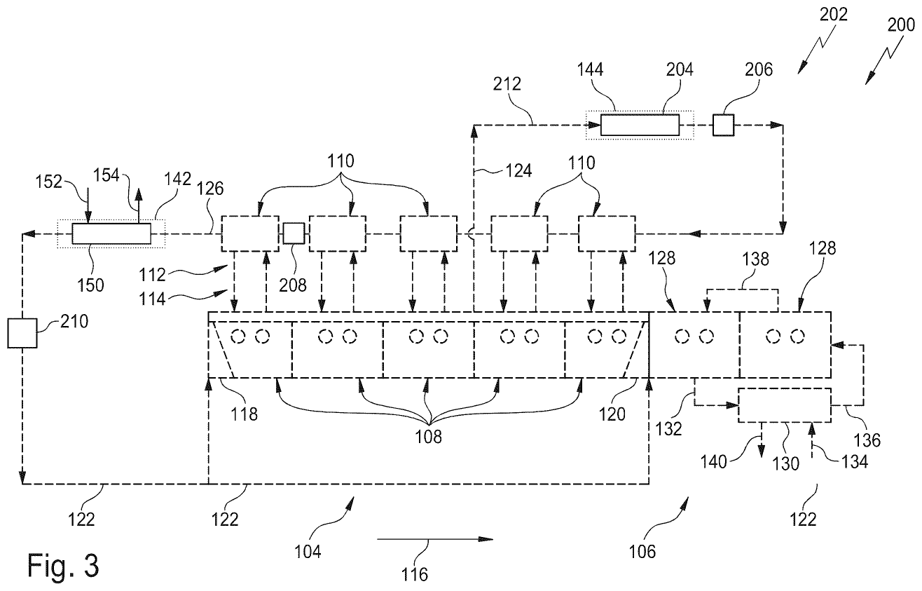

FIG. 3 illustrates a second embodiment of the treatment plant 200 converted using a conversion kit 202.

In this embodiment, the exhaust gas guide system 124 guides the exhaust gas discharged from the treatment space 104 through the purely electrically operated, flameless, regenerative thermal oxidation apparatus 204, which in this case replaces the fresh air heat exchanger 144.

The electrically operated auxiliary heating apparatus 206 is also arranged downstream of the oxidation apparatus 204 and further heats the clean gas downstream of the oxidation apparatus 204.

As a result of the alternative exchange position within the treatment plant 200, the clean gas downstream of the oxidation apparatus 204 or of the electrically operated auxiliary heating apparatus 206 flows through the clean gas guide system 126 counter to the conveying direction 116, wherein here the heat energy of the clean gas guided in the clean gas guide system 126 is in each case also transferred to the local recirculated air flows 112 by means of the heat exchangers of the recirculated air modules 110.

Equally, provision is preferably also made in the second embodiment for further electrically operated auxiliary heating apparatuses 208 to be arranged along the clean gas guide system, i.e. in particular between the recirculated air modules 110.

As an alternative to the first embodiment, the in particular fossil fuel-heated, thermal post-combustion apparatus 142, which was previously operated in an existing treatment plant, is not completely replaced but rather modified, i.e. the post-combustion is shut down and the internal heat exchanger of the post-combustion apparatus 142 is used as a fresh air heat exchanger 150, in order to transfer the remaining heat energy of the clean gas downstream of the recirculated air modules 110 to the required, supplied fresh air flow 152. The generally high-quality and very effective heat exchanger of the post-combustion apparatus 142 can thus continue to be used.

The clean gas cooled as a result of the heat transfer is discharged as cooled clean gas flow 154 into the atmosphere or via the roof.

Downstream of the fresh air heat exchanger 150, the preheated fresh air is increased by means of the further auxiliary apparatus 210 to the temperature which is preferably required for the admission lock 118 and/or discharge lock 120.

The result of the conversion is thus that the oxidation apparatus 204 substitutes the fresh air heat exchanger 144 of an existing plant at the original position thereof, whereas with minimal effort and reduced costs the in particular fossil fuel-heated, thermal post-combustion apparatus 142 remains at its position and is merely modified to the extent that its internal heat exchanger can be used as fresh air heat exchanger 150.

However, the reversal of the flow direction in the clean gas guide system 126 requires an adaptation of the exhaust air guide system 124, which must be extended by a modifying exhaust air guide system 212, such that the exhaust air can be guided to the alternative installation position of the oxidation apparatus 204 instead of the original fresh air heat exchanger 144.

It is also conceivable for there to be positioned upstream of the treatment space 104, in relation to the conveying direction 116, a pretreatment space in which the workpieces are pretreated in one or more pretreatment space portions, each pretreatment space portion being assigned a respective separate recirculated air module.

The pretreatment space may have a dedicated admission lock and/or discharge lock or intermediate lock, which is supplied with fresh air.

With respect to a converted treatment plant 200, it may be necessary to arrange further electrically operated auxiliary heating apparatuses 208 on or in the clean gas guide system 126 in order to be able to also transfer a sufficient amount of heat energy for the heat transfer from the clean gas to the local recirculated air flows 112 in the region of the pretreatment space portions.

However, the temperature level required in the pretreatment space is generally lower than in the treatment space, for which reason further electrically operated auxiliary heating apparatuses 208 between the recirculated air modules 110 assigned to pretreatment space portions may be unnecessary.

The conversion of an existing treatment plant with a pretreatment space is otherwise analogous to a plant without pretreatment, especially since the air and gas guide systems required for the pretreatment space are also already present.

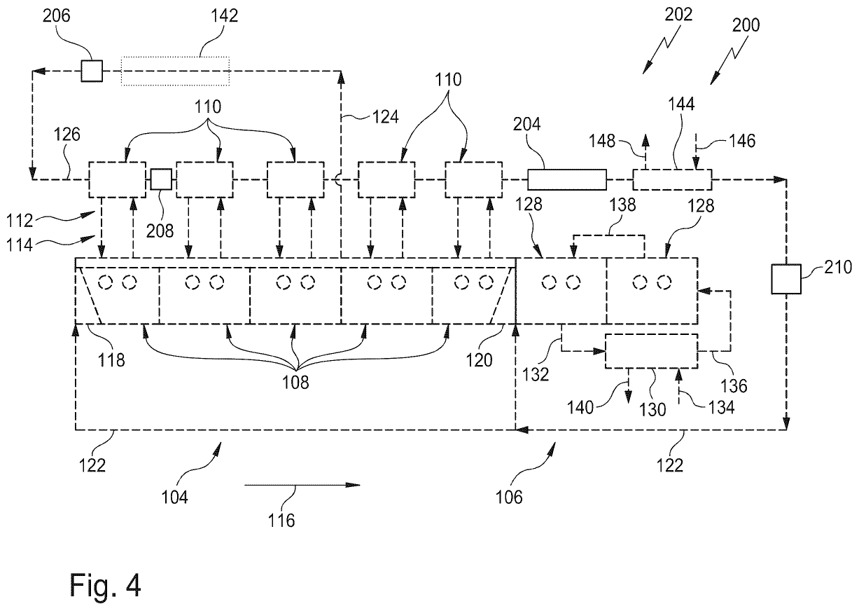

The third embodiment, illustrated in FIG. 4, of a treatment plant 200 converted using a conversion kit 202 differs from the first embodiment in that the in particular fossil fuel-heated, thermal post-combustion apparatus 142 is indeed replaced with a purely electrically operated, flameless, regenerative thermal oxidation apparatus 204, but at a different position.

At the positions indicated in FIG. 4, the original post-combustion apparatus 142 is either shut down and bridged or removed from this position.

The oxidation apparatus 204 is arranged downstream of the recirculated air modules 110 and upstream of the fresh air heat exchanger 144.

The installation of the oxidation apparatus 204 at a position other than that of the original post-combustion apparatus 142 may, for example, be due to reasons of space, which should also be understood to mean that the freed space volume at the position of the original post-combustion apparatus 142 can be used, for example, for the transformer infrastructure, i.e. in particular for an integrated unit of central electrical heat generation and central voltage transformation.

In the third embodiment, like in the first embodiment or in contrast to the second embodiment, the exhaust air is guided in the conveying direction 116 through the clean gas guide system 126, it also being the case that an electrically operated auxiliary heating apparatus 206 is provided downstream of the treatment space 104 and/or a further electrically operated auxiliary heating apparatus 208 is provided between the recirculated air modules 110, in order to additionally heat the exhaust air flow and thus ensure that the heat energy input into the local recirculated air flows 112 is sufficient for the workpiece treatment.

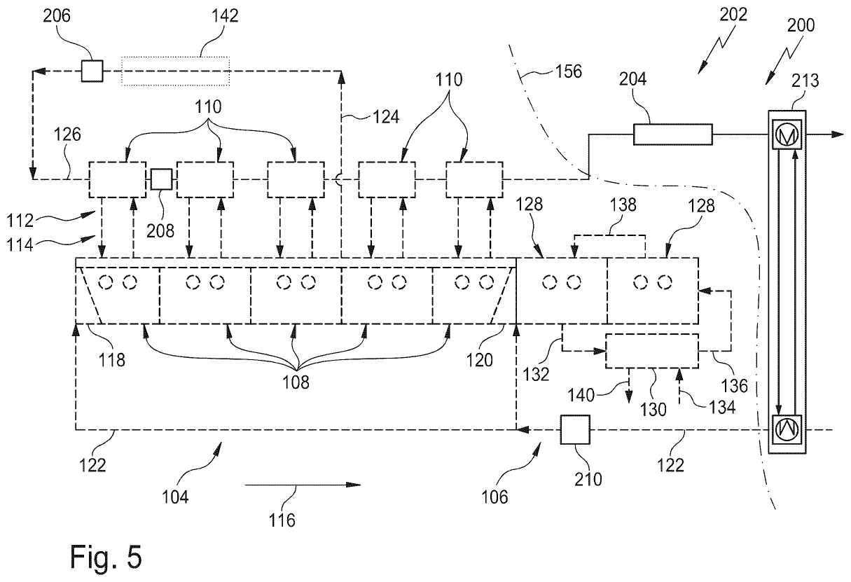

FIG. 5 illustrates a fourth embodiment of an existing treatment plant 200 converted using the conversion kit 202.

The fourth embodiment should be understood to be a variant of the third embodiment illustrated in FIG. 4, wherein it is assumed in the fourth embodiment that the oxidation apparatus 204 is to be arranged only very far away from the treatment space 104, that is to say, for example, outside a building boundary 156.

Using the exhaust air enthalpy flow in the fresh air heat exchanger 144 would thus require a high outlay with regard to additional lengths in the exhaust air guide system, i.e. additional duct length, and would possibly also necessitate additional insulation of the exhaust air guide system downstream of the recirculated air modules 110.

For this reason, use is made here of a thermal oil circuit 213 or a run-around coil (RAC) system, with the aid of which the sensible and latent heat can be transferred from the locally more remote exhaust air flow, discharged from the treatment space 104, to the fresh air required for the treatment space, in particular for the admission lock 118 and/or the discharge lock 120.

The remaining required temperature swing is in turn effected by means of an electrically operated auxiliary heating apparatus 210 as direct heating of the preheated fresh air flow guided in the fresh air guide system 122.

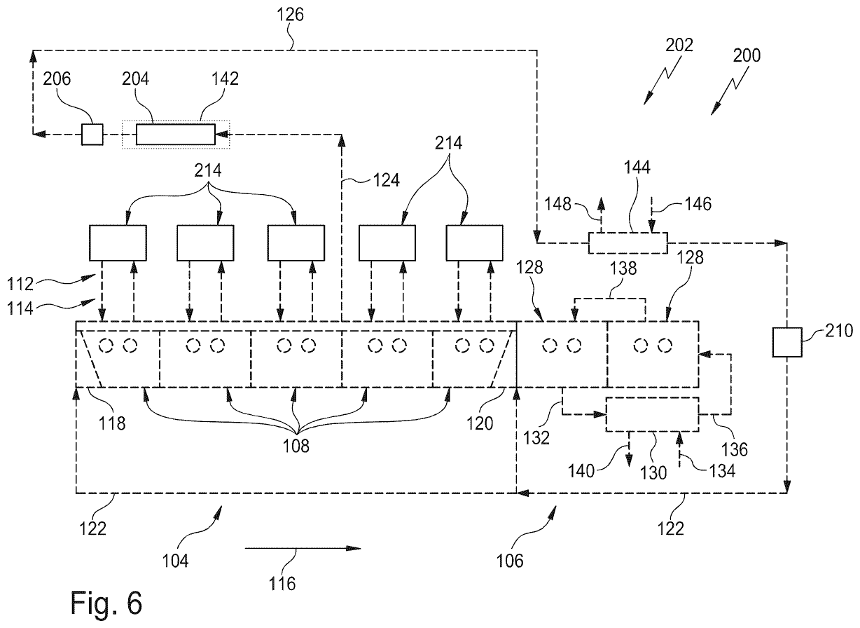

FIG. 6 shows a fifth embodiment of a treatment plant 200 converted by means of the conversion kit 202.

In a comparable manner for example to the first embodiment, in the fifth embodiment the exhaust air is also guided through the exhaust air guide system 124 to the purely electrically operated, flameless, regenerative thermal oxidation apparatus 204, the oxidation apparatus 204 replacing the in particular fossil fuel-heated, thermal post-combustion apparatus 142.

Equally, the electrically operated auxiliary heating apparatus 206 is preferably arranged downstream of the oxidation apparatus 204 in order to additionally provide heat energy to the clean gas discharged from the oxidation apparatus 204 or to further heat the clean gas. However, the auxiliary heating apparatus 206 is not necessarily required if an auxiliary heating apparatus 210 of correspondingly larger dimensions compensates for the in this case lower preheating of the fresh air.

In the exemplary comparison with the first embodiment, however, the clean gas guide system 126 is thermally decoupled from the recirculated air modules and accordingly guides the heated clean gas to the fresh air heat exchanger 144 without progressive heat transfer.

Instead of the original recirculated air modules 110, which each comprise a dedicated heat exchanger, electrically operated recirculated air modules 214 are installed or fitted, which heat the respective local recirculated air flow 112 in a decentralized manner.

Consequently, in the fifth embodiment the central and indirect heating of recirculated air modules or units which is conducted via the oxidation apparatus 204 does not apply. Nevertheless, the temperature swing in the context of the purification of the exhaust air in the oxidation apparatus 204 in the order of magnitude of about 20 K is provided to the fresh air heating in the fresh air heat exchanger 144.

The heating of the local recirculated air flows 112 is effected, comparably to the fitting of a preferably purely electrically operated new plant, in a decentralized manner by means of electrical direct heating via the corresponding recirculated air modules 214.

It is favorable if the conversion of the recirculated air modules 110 is effected in such a way that only the internal heat exchangers and the regulating flaps are dismantled, the corresponding inflows and outflows are closed and electrical heating registers are inserted into the recirculated air modules for formation of electrically operated recirculated air modules 214.

Consequently, the vertical displacement of the clean gas guide system 126 in FIG. 6 constitutes only a schematic thermal decoupling and is not intended to be synonymous with a relocation of the corresponding, real pipework.

In the case of the first, second, fourth and fifth embodiment, the oxidation apparatus 204 is preferably arranged or installed close to the dryer for the purpose of purifying the exhaust air from the treatment space 104. In this case, however, owing to the short exhaust air guide system 124 between the treatment space 104 and the oxidation apparatus 204, dynamic pressure changes which can have a negative effect on the balance of the treatment space 104 must be taken into account. The reason for this is pressure shocks which occur within the oxidation apparatus 204 as a result of recurring operations for switching the flow through the thermal bed of the oxidation apparatus 204. These switching operations are effected in dependence on the solvent concentration and the temperature for example every 3 to 7 minutes, the switching operation being effected by way of disk valves and being necessary for stabilization of the temperature profile across the thermal bed of the oxidation apparatus 204.

The described switching operation within the oxidation apparatus 204 generates undesired pressure shocks, which can have the result that the treatment space 104 in the region of the admission lock 118 and the discharge lock 120 pushes dryer atmosphere or atmosphere of the treatment space 104 into the adjoining regions or treatment space portions 108, and said atmosphere can condense there. In order to prevent this, it is advantageous if
i) the volume flow to be purified, which is supplied via the exhaust air guide system 124 to the oxidation apparatus 204, is divided, or
ii) the temporally recurring pressure shocks are buffered by means of a buffer section between the treatment space 104 and the oxidation apparatus 204.

For variant i), it is conceivable for an oxidation apparatus 204 to be configured in such a way that the volume flow to be purified is divided into two or more flows of lower volume and routed through this oxidation apparatus 204. Alternatively, two or more oxidation apparatuses 204 are arranged parallel to one another at the plant location of the oxidation apparatus 204, with the result that the volume flow to be purified can be divided among these two or more oxidation apparatuses 204.

As a result, the one or more oxidation apparatuses 204 are flowed through by flows of lower volume, as a result of which the intensity of the switching-induced pressure shocks is reduced and the atmospheric balance of the treatment space 104 is influenced to a lesser extent.

For variant ii), it is conceivable for the cross section or the diameter of the exhaust air guide system 124, which may for example be formed by a duct, to be widened from the treatment space 104 up to the oxidation apparatus 204. For example, in the case of a volume flow of approximately 12 000 standard m³/h over a length of 6 m, the diameter of the exhaust air guide system 124 could be increased from 0.6 m to 1.5 m.

FIG. 6 schematically illustrates the air connection of an oxidation apparatus 204.

The exhaust air to be purified from the treatment space 104 is supplied via the exhaust air guide system 124 to the oxidation apparatus 204, wherein for example the exhaust air can be supplied from a pre-dryer 216 via a pre-dryer exhaust air guide system 218 to the exhaust air guide system 124.

The amalgamated exhaust air of the treatment space 104 and of the pre-dryer 216 is conveyed in the direction of the oxidation apparatus 204 by means of a first fan 220, wherein said exhaust air is first guided into a buffer duct 222 downstream of the first fan 220.

The volume flow from the buffer duct 222 in the direction of the oxidation apparatus is controlled and/or regulated by way of a valve device 224.

A second fan (not illustrated) is assigned to the oxidation apparatus 204 and is preferably arranged upstream thereof. All internal pressure losses, such as 4000 Pa to 6000 Pa at 20° C., of the oxidation apparatus 204 are taken on by this second fan.

A third fan 226 is arranged downstream of the oxidation apparatus and upstream of the auxiliary heating apparatus 206 in the clean gas guide system 126. This third fan 226 overcomes all clean gas pressure losses downstream of the oxidation apparatus 204, such as 4000 Pa to 7000 Pa at 20° C.

In the case, for example, of a malfunction of the oxidation apparatus 204, a bypass guide system 228 also branches off from the exhaust air guide system 124 downstream of the buffer duct 222 and is supplied to the clean gas guide system 126, wherein the volume flow of the bypass guide system 228 can be controlled and/or regulated by way of a further valve device 230.

To coordinate the respective volume flows, the valve device 224 of the exhaust air guide system and the valve device 230 of the bypass guide system 228 are coupled to one another, preferably electrically.

Purge air for controlling and/or regulating the temperature of the thermal bed of the oxidation apparatus 204 can also be supplied via a purge air guide system 232 to a separate chimney 234, the volume flow here also being able to be controlled and/or regulated by way of a further valve device 236.

The oxidation apparatus 204 is also supplied via a fresh air guide system 238, the volume flow of which can be controlled and/or regulated by way of a further valve device 240, with fresh air, such as hall air or ambient air, for the oxidation process.

The valve device 236 of the purge air guide system 232 and the valve device 240 of the fresh air guide system 240 are also preferably connected to one another, in particular electrically, to coordinate the respective volume flows.

### LIST OF REFERENCE SIGNS

100 Treatment plant basic structure
102 Dryer basic structure
104 Treatment space
106 Aftertreatment space
108 Treatment space portion
110 Recirculated air module
112 Local recirculated air flow
114 Local recirculated air guide system
116 Conveying direction
118 Admission lock
120 Discharge lock
122 Fresh air guide system
124 Exhaust air guide system
126 Clean gas guide system
128 Aftertreatment space portions
130 Fresh air heat exchanger
132 Exhaust air flow
134 Supplied fresh air flow
136 Preheated fresh air flow
138 Recirculated air flow
140 Cooled exhaust air flow
142 Post-combustion apparatus
144 Fresh air heat exchanger
146 Supplied fresh air
148 Cooled clean gas flow
150 Fresh air heat exchanger
152 Fresh air flow
154 Cooled clean gas flow
156 Building boundary
200 Converted treatment plant
202 Conversion kit
204 Regenerative thermal oxidation apparatus
206 Electrically operated auxiliary heating apparatus
208 Electrically operated auxiliary heating apparatus
210 Electrically operated auxiliary heating apparatus
212 Modifying exhaust air guide system
213 Thermal oil circuit
214 Electrically operated recirculated air modules
216 Pre-dryer
218 Pre-dryer exhaust air guide system
220 First fan
222 Buffer duct
224 Valve device
226 Third fan
228 Bypass guide system
230 Valve device
232 Purge air guide system
234 Chimney
236 Valve device
238 Fresh air guide system
240 Valve device

1. A conversion kit, which is suitable for the conversion of a treatment plant, optionally an existing treatment plant, for treating workpieces, optionally drying vehicle bodies, the conversion comprising:
one or more auxiliary heating apparatuses, which are suitable for heating a clean gas guided in a clean gas guide system and/or fresh air guided in a fresh air guide system; and
a) a regenerative thermal oxidation apparatus as replacement for an optionally fossil fuel-heated, thermal post-combustion apparatus; or
b) a regenerative thermal oxidation apparatus as replacement for a fresh air heat exchanger and a converted, optionally fossil fuel-heated, thermal post-combustion apparatus for use as fresh air heat exchanger; or
c) a regenerative thermal oxidation apparatus as replacement for an optionally fossil fuel-heated, thermal post-combustion apparatus and electrically heated recirculated air modules as replacement for recirculated air modules having heat exchangers or converted recirculated air modules having electrical heating registers instead of heat exchangers.

2. The conversion kit as claimed in claim 1, wherein the treatment plant to be converted has a conveying direction and includes:
a treatment space which includes a plurality of treatment space portions which are each assigned to a separate recirculated air module, each of which includes a heat exchanger;
an exhaust air guide system which discharges exhaust air from the treatment space;
the optionally fossil fuel-heated, thermal post-combustion apparatus for processing, optionally for cleaning, the exhaust air, which is intended to be converted or exchanged;
a clean gas guide system which guides cleaned exhaust air, optionally clean gas, wherein the clean gas guide system preferably runs at least approximately parallel to the conveying direction; and
a fresh air supply which supplies fresh air to the treatment space.

3. The conversion kit as claimed in claim 2, wherein the treatment plant to be converted further includes a fresh air heat exchanger which is designed to transfer heat energy contained in the clean gas to fresh air supplied to the treatment plant.

4. The conversion kit as claimed in claim 1, wherein the one or more auxiliary heating apparatuses are purely electrically operated, hydrogen-operated or thermal oil-operated auxiliary heating apparatuses.

5. The conversion kit as claimed in claim 1, wherein the regenerative thermal oxidation apparatus is a purely electrically operated, in particular flameless, regenerative thermal oxidation apparatus.

6. The conversion kit as claimed in claim 1, wherein the one or more purely electrically operated auxiliary heating apparatuses and/or the purely electrically operated, in particular flameless, regenerative thermal oxidation apparatus can be connected to a central electrical connection point, optionally to a unit substation.

7. The conversion kit as claimed in claim 1, wherein the regenerative thermal oxidation apparatus includes a fan for conveying an air flow.

8. The conversion kit as claimed in claim 1, wherein, in the case of c), the clean gas can be guided exclusively to the fresh air heat exchanger by the clean gas guide system.

9. The conversion kit as claimed in claim 1, wherein, in the case of a) and c), the clean gas guide system can be flowed through in the conveying direction.

10. The conversion kit as claimed in claim 1, wherein, in the case of b), the clean gas guide system can be flowed through counter to the conveying direction.

11. The conversion kit as claimed in claim 1, wherein the regenerative thermal oxidation apparatus is arranged at an end of the clean gas guide system in relation to the conveying direction.

12. The conversion kit as claimed in claim 1, wherein the fresh air heat exchanger is in the form of a thermal oil circuit or in the form of a run-around coil system.

13. A method for the conversion of a treatment plant, optionally an existing treatment plant, for treating workpieces, optionally drying vehicle bodies, wherein the treatment plant to be converted has a conveying direction, and wherein the treatment plant to be converted includes the following:
a treatment space which comprises a plurality of treatment space portions which are each assigned to a separate recirculated air module, each of which comprises a heat exchanger;
an exhaust air guide system which discharges exhaust air from the treatment space;
an optionally fossil fuel-heated, thermal post-combustion apparatus for processing, optionally for cleaning, the exhaust air, which is intended to be converted or exchanged;
a clean gas guide system which guides cleaned exhaust air, optionally clean gas;
a fresh air heat exchanger which transfers heat energy contained in the clean gas to fresh air supplied to the treatment plant; and
a fresh air supply which supplies fresh air via the fresh air heat exchanger to the treatment space;
the method comprising:
installing one or more purely electrically operated auxiliary heating apparatuses in the clean gas guide system and/or the fresh air supply; and
a) replacing the optionally fossil fuel-heated, thermal post-combustion apparatus with a purely electrically operated, preferably flameless, regenerative thermal oxidation apparatus; or
b) replacing the fresh air heat exchanger with a purely electrically operated, preferably flameless, regenerative thermal oxidation apparatus and converting the optionally fossil fuel-heated, thermal post-combustion apparatus for use as fresh air heat exchanger; or
c) replacing the optionally fossil fuel-heated, thermal post-combustion apparatus with a purely electrically operated, preferably flameless, regenerative thermal oxidation apparatus and replacing the recirculated air modules having heat exchangers with electrically operated recirculated air modules or replacing the heat exchangers of the recirculated air modules with electrical heating registers.

14. The method as claimed in claim 13, wherein the one or more purely electrically operated, hydrogen-operated or thermal oil-operated auxiliary heating apparatuses and/or the purely electrically operated, preferably flameless, regenerative thermal oxidation apparatus are connected to a central electrical connection point, optionally to a unit substation.

15. The method as claimed in claim 13, wherein, in the case of b), the optionally fossil fuel-heated, thermal post-combustion apparatus of the treatment plant to be converted continues to be used as fresh air heat exchanger.

16. The method as claimed in claim 13, wherein, in the case of a) and c), the clean gas guide system is flowed through by the clean gas in the conveying direction.

17. The method as claimed in claim 13, wherein, in the case of b), the clean gas guide system is flowed through by the clean gas counter to the conveying direction.

18. The method as claimed in claims 13, wherein the exhaust air is guided at least partially or at least approximately completely through the purely electrically operated, preferably flameless, regenerative thermal oxidation apparatus and in so doing is at least temporarily heated to a temperature which brings about a chemical transformation of substances, optionally solvents, contained in the air flow, and wherein at least part of the heat temporarily contained in the exhaust air is recovered, with the result that the clean gas leaves the purely electrically operated, preferably flameless, regenerative thermal oxidation apparatus at a temperature which lies between an input temperature and a temporary maximum temperature.
